(19) United States
(12) Patent Application Publication
(10) Pub. No.: US 2009/0032351 A1
(43) Pub. Date: Feb. 5, 2009

(54) Combined sealing plate and leaf spring drive-plate

(75) Inventor: Adam Uhler, Sterling, OH (US)

Correspondence Address: Davidson, Davidson & Kappel, LLC, 485 7th Avenue, 14th Floor, New York, NY, 10018, US

(73) Assignee: LuK Lamellen und Kupplungsbau Beteiligungs KG, Buehl (DE)

(21) Appl. No.: 11/981,289

(22) Filed: Oct. 31, 2007

Related U.S. Application Data
(60) Provisional application No. 60/962,772, filed on Jul. 31, 2007.

(51) Int. Cl. F16D 33/18

(52) U.S. Cl. 192/3.29

(57) ABSTRACT

A hydraulic torque converter including a cover, a drive-plate driven by the cover, and a lock-up clutch having a piston plate, the piston plate being located between the drive plate and the cover, the piston plate and drive plate defining a hydraulic chamber for actuation of the piston plate.

Priority to U.S. Provisional Application Ser. No. 60/962,772, filed Jul. 31, 2007, German Patent Application No. 10 2006 056 299.2, filed Nov. 29, 2006, U.S. Provisional Patent Application Ser. No. 60/874,104, filed Dec. 11, 2006, German Patent Application No. 10 2006 061 541.7, filed Dec. 27, 2006, German Patent Application No. 10 2006 061 553.0, filed Dec. 27, 2006, German Patent Application No. 10 2006 061 552.2, filed Dec. 27, 2006, U.S. Provisional Patent Application Ser. No. 60/934,235, filed Jun. 12, 2007, and U.S. Provisional Patent Application Ser. No. 60/964,855, filed Aug. 15, 2007, is claimed.

The present invention relates generally to torque converters and more particularly to a torque converter having a combined sealing plate and leaf spring drive-plate.

### BACKGROUND

FIG. 1 shows the established state of the art for a torque converter 10 with three hydraulic passages entering torque converter 10. Torque converter 10 includes a torque converter cover 4 and a stud 2 connected to cover 4 which receives the torque from the engine. Enclosed in cover 4 is a turbine 46 rotatable with respect to cover 4 and a stator 44 installed between an impeller 40 and turbine 46. Cover 4 has a tubular impeller hub 16. Impeller hub 16 is spaced from a stator shaft 8 splined to stator 44. Turbine 46 is non-rotatably connected to a turbine hub 20, and turbine hub 20 is connected to an input shaft 14 through a damper 38 and a damper hub 62. There is relative rotation between turbine hub 20 and damper hub 62 when damper 38 is compressed. Torque converter 10 also includes a clutch piston 30 and clutch plates 6. One clutch plate 6 is rotatably connected to a welding plate 48 and another clutch plate 6 rotatably connected to cover 4 by leaf springs 64. The three passages entering torque converter 10 are: between impeller hub 16 and stator shaft 8; between stator shaft 8 and input shaft 14, and inside a channel drilled into input shaft 14.

The advantages in the current state of the art are the passages give the ability to control three pressures inside torque converter 10 to engage, disengage and cool clutches. However, the disadvantages include the complexity of the three passage design.

The three hydraulic passages of torque converter 10 allow for a closed piston chamber 12 which controls the engagement of torque converter clutch 60. Piston 30 is typically sealed in torque converter cover 4 and input shaft 14. Piston 30 applies clutch 60 towards turbine 46 which requires some type of axial stop for torque converter clutch 60. Welded plate 48 made of thick steel, is welded into cover 4 of torque converter 10.

### SUMMARY OF THE INVENTION

An object of the present invention provides a hydraulic torque converter comprising: a cover, a drive-plate driven by the cover, and a lock-up clutch having a piston plate, the piston plate being located between the drive plate and the cover, the piston plate and drive plate defining a hydraulic chamber for actuation of the piston plate.

### BRIEF DESCRIPTION OF THE DRAWINGS

FIG. 1 illustrates state of the art of the upper half of a longitudinal section through a torque converter with the piston sealed in the torque converter cover and the input shaft.

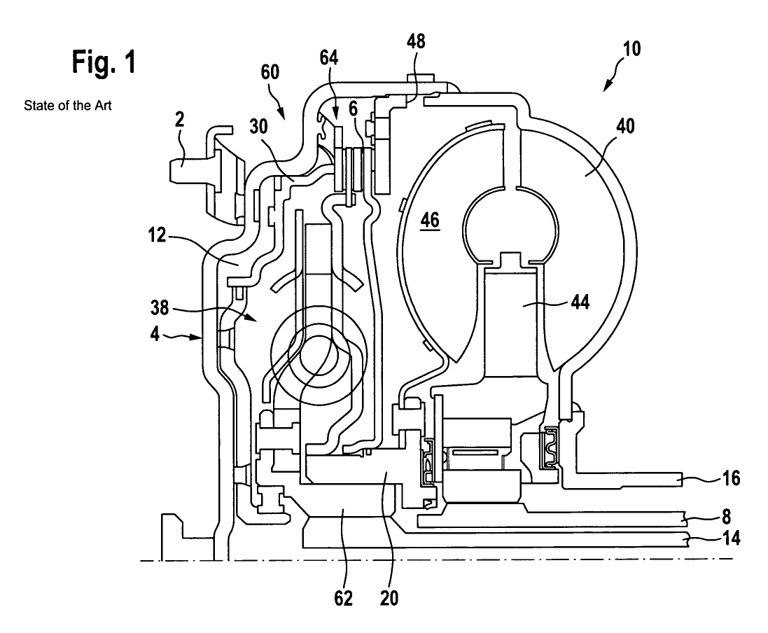

Further features and advantages of the invention will become apparent from the following detailed description taken in conjunction with the accompanying drawings, in which:

FIG. 2 illustrates one embodiment of a torque converter according to the present invention.

FIG. 3 illustrates another embodiment of the present invention where the torque converter clutch applies pressure through the center of the input shaft.

### DETAILED DESCRIPTION

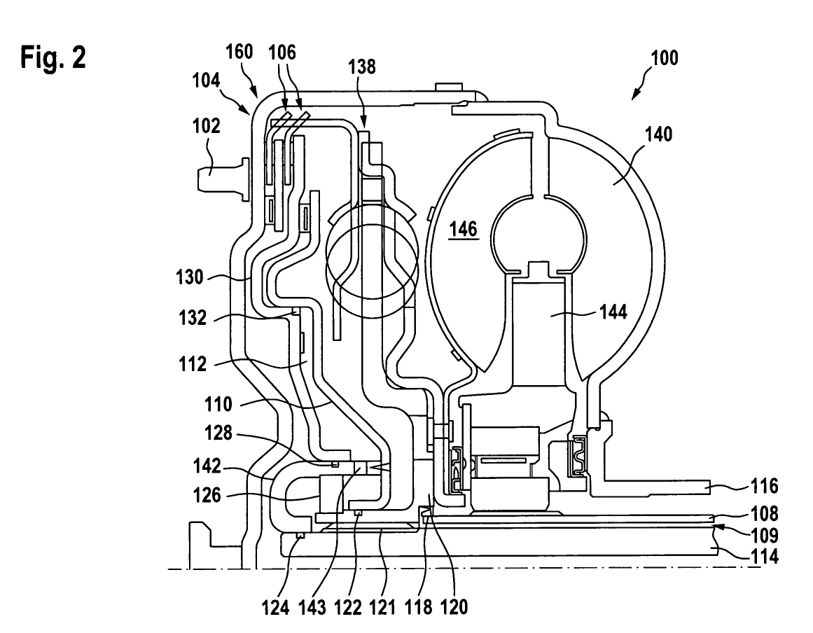

FIG. 2 shows a section of a hydraulic torque converter 100 embodying the present invention. Torque converter 100 has a cover 104 and a stud 102 connected to cover 104. Cover 104 has a tubular impeller hub 116. Inside cover 104 is an impeller 140, a turbine 146 connected to a turbine hub 120 and a stator 144. Impeller hub 116 is spaced from a stator shaft 108 splined to stator 144. A transmission input shaft 114 is splined 121 to turbine hub 120. Stator shaft 108 is sealed to turbine hub 120. Cover 104 also is fixed to a centering sleeve 142 which is fixed to a leaf-spring drive plate 110.

Torque converter 100 also has a lockup or bypass clutch 160, which includes piston 130 and clutch plates 106, and has a damper 138. Piston 130 is sealed to leaf-spring drive plate 110 by a seal 132. Piston 130 is also sealed to centering sleeve 142 with a seal 128. Turbine hub 120 is sealed to leaf spring drive-plate 110 with a seal 122. Centering sleeve 142 is sealed to input shaft 114 with a seal 124. Turbine hub 120 rotates with respect to centering sleeve 142, for example via an optional centering sleeve, turbine hub 120 being able to pass optional centering bearing 126. Centering sleeve 142 also has at least one opening 143 permitting fluid to pass from an actuation conduit 109, between stator shaft 108 and input shaft 114 to a chamber 112. Pressure chamber 112 is an enclosed pressure chamber for actuating piston 130. Outer diameter of chamber 112 is sealed between piston plate 130 and leaf spring drive plate 110 with seal 132

Engine torque comes into converter 100 through stud 102 for example via an internal combustion engine. Torque from stud 102 is transmitted to cover 104. Torque from cover 104 may be transmitted to impeller 140, and to leaf spring drive-plate 110 through centering sleeve 142. Cooling flow enters through the center of input shaft 114 and exits between stator shaft 108 and impeller hub 116.

To close clutch 160, oil flows through actuation conduit 109 past turbine hub splines 121, bearing 126, through holes 143 to chamber 112 to engage piston 130. Piston 130 applies clutch plates 106 against cover 104 to transmit torque into damper 138. To open the clutch piston 160 the pressure in chamber 112 is vented through actuation conduit 109 between stator shaft 108 and input shaft 114. Oil passes through centering bearing 126. Centering bearing 126 may not be required depending on the design. It does not seal any portion of the chamber.

The advantages of the present invention include a reduction in complexity of the three passage design with a sealed piston, turbine damper and high slip capacity clutch. The design can eliminate welding of the clutch plate inside the cover and a reduction in material and/or a number of parts.

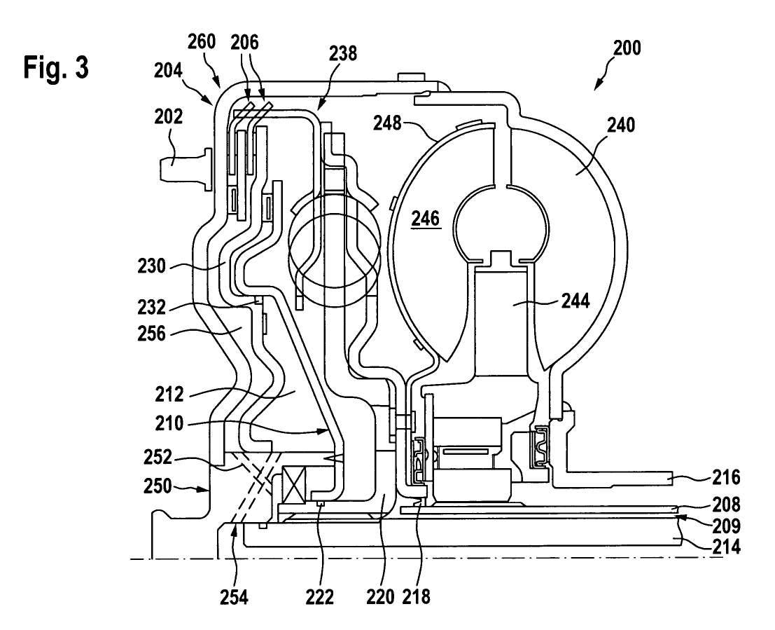

FIG. 3 shows another embodiment of the present invention. Similar to FIG. 2, FIG. 3 shows a section of a hydraulic torque converter 200. Torque converter 200 has a cover 204 and is connected to a stud 202. Cover 204 includes pilot 250. Inside cover 204 is an impeller 240, a turbine 246 with a turbine shell 248 and a stator 244. Impeller hub 216 is spaced from a stator shaft 208 and an input shaft 214. A turbine hub 220 is tightly riveted to shell 248 to create a fluid tight seal. Turbine shell 220 is sealed onto stator shaft 208 with a seal 218 creating a pressure chamber 212.

Torque converter 200 also includes a torque converter clutch 260 with a piston 230, clutch plates 206 and a damper 238. Piston 230 is sealed to leaf-spring drive plate 210 by seal 232. Turbine hub 220 is sealed to leaf spring drive-plate 210 with a seal 222.

Engine torque comes into converter 200 through stud 202. Torque from stud 202 is transmitted to cover 204. Torque from cover 204 may be transmitted to impeller 240 and leaf spring drive-plate 210. Cooling flow enters between stator shaft 208 and input shaft 214, at actuation conduit 209. The cooling flow passes through a cross drilled hole 252 to enter a chamber 256. Cooling flow exits between stator shaft 208 and impeller hub 216. To actuate clutch 260, actuation fluid enters through the center of input shaft 214. The pressure is channeled to chamber 212 through a cross drilled hole 254 in pilot 250 to enter pressure chamber 212. Cross drilled hole 254 is in a different rotational plane that cross drilling 252.

What is in the claims is:

1. A hydraulic torque converter comprising:
a cover,
a drive-plate driven by the cover; and
a lock-up clutch having a piston plate, the piston plate being located between the drive plate and the cover, the piston plate and drive plate defining a hydraulic chamber for actuation of the piston plate.

2. The hydraulic torque converter as recited in claim 1 further comprising a turbine and a damper, the damper being located between the drive plate and the turbine.

3. The hydraulic torque converter as recited in claim 1 further comprising a centering sleeve fixed to the drive plate and the cover.

4. The hydraulic converter as recited in claim 1 wherein the piston plate is sealed to the drive plate.

5. The hydraulic converter as recited in claim 3 wherein the centering sleeve has at least one opening.

6. The hydraulic converter as recited in claim 1 wherein an outer diameter of the chamber is sealed between the piston plate and the drive plate.

7. The hydraulic converter as recited in claim 1 wherein the drive plate is a leaf spring drive plate.

8. The hydraulic converter as recited in claim 1 further comprising a stator splined to a stator shaft and a turbine hub splined to an input shaft, the hydraulic chamber being fluidly connected to an actuation conduit between the stator shaft and the input shaft.

9. The hydraulic converter as recited in claim 1 wherein the turbine hub splined to an input shaft, the hydraulic chamber being fluidly connected to an inside of the input shaft.
